(19) United States
(12) Patent Application Publication
(10) Pub. No.: US 2012/0037618 A1
(43) Pub. Date: Feb. 16, 2012

(54) FLEXIBLE KITCHEN CONTAINER

(75) Inventor: Ruth Pérez, Barcelona (ES)

(73) Assignee: LEKUE, S.L., LA LLAGOSTA BARCELONA (ES)

(21) Appl. No.: 13/205,505

(22) Filed: Aug. 8, 2011

(30) Foreign Application Priority Data
Aug. 10, 2010 (ES) U 201000851

(51) Int. Cl. H05B 6/80; A47J 37/01

(52) U.S. Cl. 219/725; 220/573.1

(57) ABSTRACT

A kitchen container (10) is made of a flexible material fit for culinary applications, such as a silicone elastomer, and it has the shape of a bowl with a base (11), a perimetric wall (12) and a perimetric rim (13) that forms an upper opening. The perimetric wall (12) is flexible enough to allow first and second opposite sides (12a, 12b) thereof to be bent towards each other, and they are provided with fastening elements (14, 15) to fasten said first and second opposite sides (12a, 12b) of the perimetric wall (12) to each other in such a position that portions of the first and second sides (12a, 12b) of the perimetric wall (12) overlap each other and said perimetric rim (13) forms two opposite openings separated by said overlapping portions. In the bent, fastened position, it is useful for cooking in a microwave and a conventional oven.

### FIELD OF THE ART

The present invention relates to a kitchen container made of a flexible material for culinary applications, such as a silicone elastomer, capable of being deformed to adopt different positions befitting different uses, in particular cooking in a microwave and in a conventional oven, and it is washable in a dishwasher.

### BACKGROUND OF THE INVENTION

International Patent Application WO 2008/112717 describes a flexible bowl, made of silicone or another similar material, having a base, a circumferential wall and a rim that defines an upper opening. The circumferential wall is flexible so as to allow the opposite sides thereof to lean towards each other forming a spout-like outlet groove to allow for the efficient pouring or extraction of the food. The base is thick in order to provide stability. The container is fit for dishwashers, and for microwave and conventional ovens. In this container, however, it is not contemplated that the opposite sides of the circumferential wall, once deformed, be fastened to each other to provide a partially closed container with specific properties for cooking in a microwave and a conventional oven.

### DISCLOSURE OF THE INVENTION

The present invention provides a kitchen container, made of a flexible material fit for culinary applications, such as an elastomer, preferably based on silicone, comprising a base, a perimetric wall and a perimetric rim that forms an upper opening, wherein said perimetric wall is flexible enough to allow first and second opposite sides thereof to be bent towards each other. The container is characterised in that, in addition, it comprises fastening elements to fasten said first and second opposite sides of the perimetric wall to each other in such a position that portions of the first and second sides of the perimetric wall are mutually overlapped and said perimetric rim forms two opposite openings separated by said overlapping portions.

Said fastening elements are made of the same flexible material and form one single body together with the base and the perimetric wall.

In one embodiment, the fastening elements comprise a slit formed in the first side of the perimetric wall and a tab extending from the second side of the perimetric wall to be inserted in said slit when the perimetric wall is deformed.

Preferably, has smooth edges and forms an angle with the second side of the perimetric wall when the kitchen container is in an open position free from external pressure, said angle being sufficient to retain the tab in the slit when the kitchen container is deformed in a bent, fastened position. Said angle is selected so that, when the kitchen container is in said bent, fastened position, the tab can be released from the slit by simply pressing the tab or the second side of the perimetric wall downwards, or, more properly, in a direction opposite the direction of insertion of the tab in the slit.

Alternatively, the tab could have serrated edges in the shape of a harpoon to lock into the slit, whereby a firmer fastening would be achieved, although the release operation would be more complicated.

When the kitchen container is in said open position free from external pressure and, as a result, not deformed, the upper opening formed by the perimetric rim is substantially circular or elliptical, and the container can be used as a conventional bowl, for instance for holding, rinsing, mixing food, etc. When the kitchen container is deformed in the bent, fastened position, the two openings formed by the perimetric rim have substantially the form of a tear and facilitate air circulation through the partially closed container, so that in this partially closed position the container is useful, for instance, for cooking food in a microwave and a conventional oven, and it is especially suitable if the oven is a convection oven provided with means of internal recirculation of hot air. The circulation of hot air through the kitchen container can be regulated varying the orientation thereof inside the oven.

The base of the container has a bottom surface that, when the kitchen container is in an open position free from external pressure, is substantially to provide stability to the container. The perimetric wall has a progressively increasing thickness from an edge connecting it to the base up to the perimetric rim forming the upper opening. Preferably, the base and the perimetric wall exhibit a common smooth, continuous inner surface, without a groove along said connecting edge. Optionally, the base and the perimetric wall also exhibit a common smooth, continuous outer surface. These smooth, continuous surfaces greatly facilitate the washing of the container, which can be carried out in a dishwasher, and they are favourable to cooking in a microwave and a conventional oven.

### BRIEF DESCRIPTION OF THE DRAWINGS

The above and other characteristics and advantages will be more fully understood from the following detailed description of an exemplary embodiment with reference to the attached drawings, wherein:

FIG. 1 is a perspective view of a flexible kitchen container according to an embodiment of the present invention in an open position;

FIG. 2 is a plan view of the container of FIG. 1;

FIG. 3 is a cross-sectional view taken along the plane III-III of FIG. 2;

FIG. 4 is a perspective view of the container of FIG. 1 in a partially closed position;

FIG. 5 is a plan view of the container in the partially closed position of FIG. 4;

FIG. 6 is a perspective view of the container being open with a finger starting from the partially closed position;

FIG. 7 is a plan view of a flexible kitchen container according to an embodiment variant; and

FIG. 8 is a plan view of a flexible kitchen container according to another embodiment variant.

### DETAILED DESCRIPTION OF EXEMPLARY EMBODIMENTS

Referring firstly to FIG. 1, reference number 10 designates in general a flexible kitchen container according to an embodiment of the present invention. Said kitchen container 10 is made as one single body of a flexible material fit for culinary applications, such as an elastomer, and, more preferably, a silicone-based elastomer. The kitchen container 10 comprises a base 11, a perimetric wall 12 and a perimetric rim 13 that forms an upper opening. Said perimetric wall 12 is flexible enough to allow first and second opposite sides 12a, 12b thereof to be bent towards each other. A slit 14 is formed in the first side 12a of the perimetric wall 12 and a tab 15 extends from the second side 12b of the perimetric wall 12.

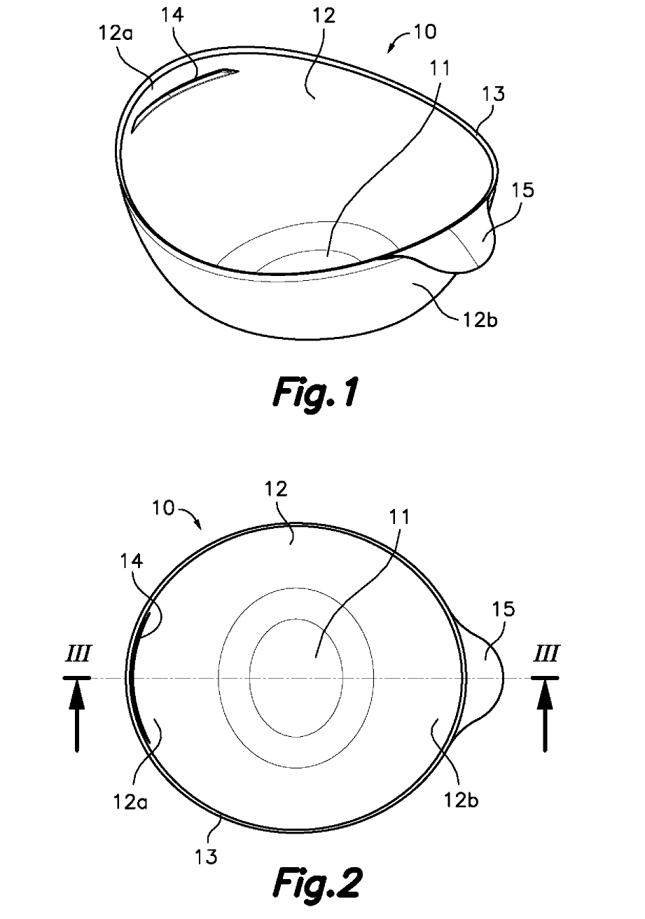

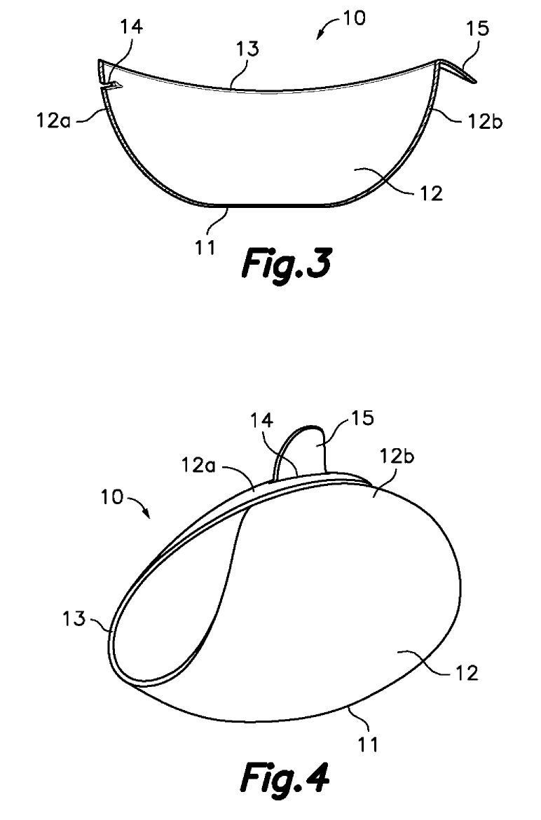

FIGS. 1, 2 and 3 show the kitchen container 10 in an open position, which is the one it naturally adopts when it is free from external pressure. In this situation, the upper opening formed by the perimetric rim 13 is substantially circular or elliptical (FIG. 2), and the base 11 has a substantially flat bottom surface (FIG. 3) to provide stability to the kitchen container 10 when it rests on a table or another supporting horizontal surface. Said tab 15 forms an acute angle with the second side 12b of the perimetric wall 12 when the kitchen container is in said open position free from external pressure.

As shown in FIG. 3, the base 11 has a substantially uniform thickness, whereas the perimetric wall 12 has a progressively increasing thickness from an edge connecting it to the base 11 up to the perimetric rim 13 forming the upper opening. The base 11 and the perimetric wall 12 exhibit a common smooth, continuous inner surface, which facilitates cleaning and is favourable to cooking in a microwave and a conventional oven.

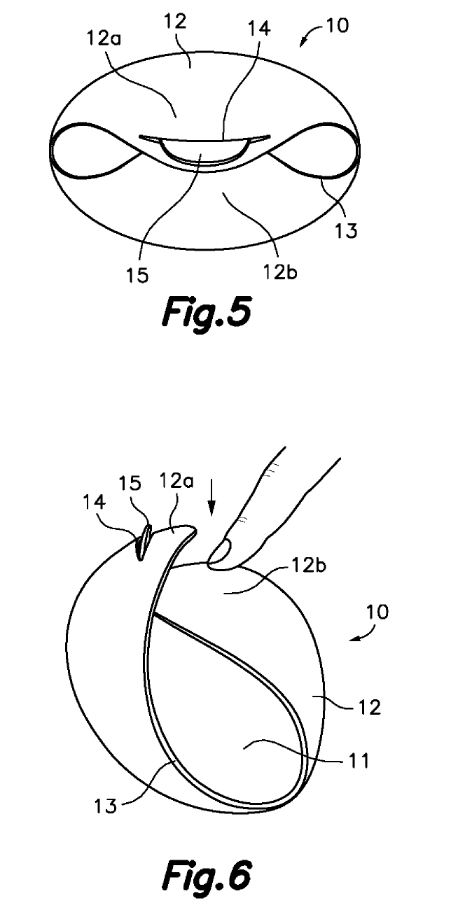

As shown in FIGS. 4 and 5, the slit 14 and the tab 15 form fastening elements to fasten said first and second opposite sides 12a, 12b of the perimetric wall 12 to one another when the kitchen container 10 is deformed to a bent, fastened, partially closed position, wherein portions of the first and second sides 12a, 12b thereof are mutually overlapped and said perimetric rim 13 forms two opposite openings separated by said overlapping portions (FIG. 5). These two openings formed by the perimetric rim 13 when the kitchen container 10 is in said bent, fastened position have substantially the form of a tear and facilitate the convection circulation of hot air through the container during cooking in a microwave and a conventional oven, whereas the first and second opposite sides 12a, 12b of the perimetric wall 12, bent towards each other, partially retain the vapours generated by the food during cooking.

Alternatively, the portions adjacent to the first and second sides 12a, 12b of the perimetric wall 12 can simply touch in one point or be very close to each other without touching when the kitchen container 10 is in the bent, fastened position if the configuration of the fastening elements so allows.

The tab 15 has a shape and dimensions adequate to be freely inserted in said slit 14, and the acute angle formed by the tab 15 with the second side 12b of the perimetric wall 12 is selected so that the tab 15 will engage the slit 14 and become retained by it as a result of the force exerted by the kitchen container 10 as it tries to elastically regain the open position. In the bent, fastened position, the tab 15 inserted in the slit 14 protrudes from an upper part of the kitchen container 10 and can be used as a handle to hold the container, especially when the base 11 and the perimetric wall 12 are hot.

In relation now to FIG. 6, the acute angle formed by the tab 15 with the second side 12b of the perimetric wall 12 is also selected so that, when the kitchen container 10 is in the bent, fastened position, the tab 15 can be released from the slit 14 in an easy and fast manner by simply pressing the second side 12b of the perimetric wall 12 in a disengagement direction opposite the direction of insertion of the tab 15 in the slit 14. Alternatively, the tab 15 can be released from the slit 14 by directly pressing on tab 15 in the disengagement direction. This release operation is so simple that it can be carried out, for instance, with one single finger.

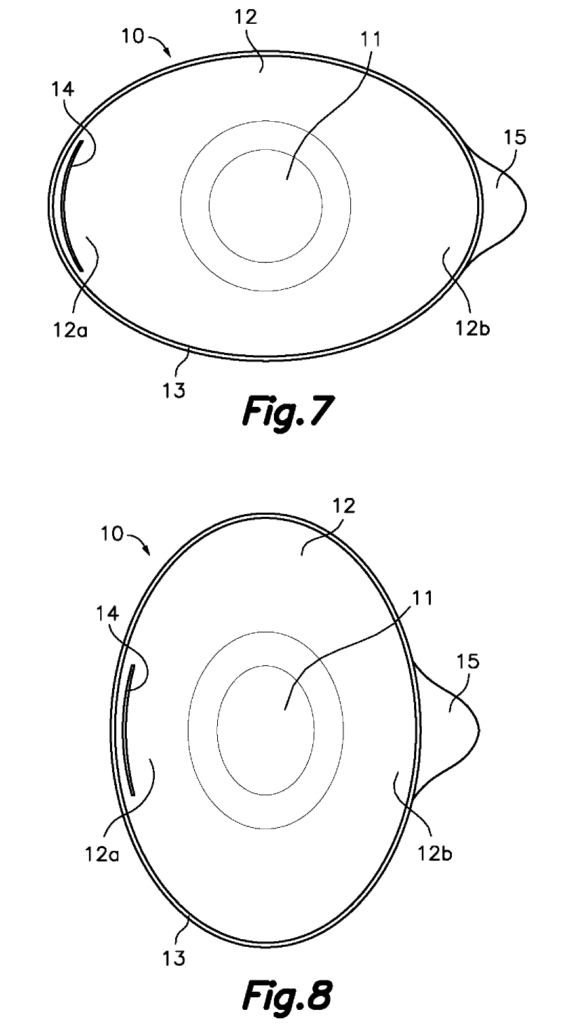

FIG. 7 shows a flexible kitchen container according to a variant of the previously described embodiment with reference to FIGS. 1 to 6, to which it is entirely analogous, except that the perimetric wall 12 is configured so that, in the open position and in a rest situation, the upper opening formed by the perimetric rim 13 defines an elliptical shape wherein the distance from the tab 15 to the slit 14 is significantly larger than the greatest distance between the opposite portions of the perimetric wall 12 situated therein.

FIG. 8 shows another embodiment variant of the kitchen container wherein the upper opening formed by the perimetric rim 13 of the perimetric wall 12 also defines, when it is in the open position and in a rest situation, an elliptical shape, although in this case the distance from the tab 15 to the slit 14 is significantly smaller than the greatest distance between the opposite portions of the perimetric wall 12 situated therein.

From the exemplary embodiment shown and described, modifications and variations will occur to the skilled artisan without departing from the scope of the present invention as defined in the enclosed claims.

What is claimed is:

1. A flexible kitchen container (10), made of flexible material fit for culinary applications, comprising a base (11), a perimetric wall (12) and a perimetric rim (13) that forms an upper opening, wherein said perimetric wall (12) is flexible enough to allow first and second sides (12a, 12b) thereof that are opposite each other to be bent towards each other, characterised in that the kitchen container (10) comprises, in addition, fastening elements allowing to fasten said first and second sides (12a, 12b) of the perimetric wall (12) to each other in a bent, fastened position wherein portions of the first and second sides (12a, 12b) of the perimetric wall (12) are in mutual contact or very close to one another and said perimetric rim (13) forms two opposite openings separated by said portions of the first and second sides (12a, 12b) of the perimetric wall (12) to facilitate air circulation through the container and a partial retention of vapours while cooking in a microwave or a conventional oven.

2. The container according to claim 1 characterised in that said base (11), said perimetric wall (12) and said fastening elements make up one single body.

3. The container according to claim 1 characterised in that said fastening elements comprise a slit (14) formed in the first side (12a) of the perimetric wall (12) and a tab (15) extending from the second side (12b) of the perimetric wall (12) to be inserted in said slit (14).

4. The container according to claim 3 characterised in that said tab (15) forms an angle with the second side (12b) of the perimetric wall (12) when the kitchen container (10) is in an open position free from external pressure, said angle being sufficient to retain the tab (15) in the slit (14) when the kitchen container (10) is in a bent, fastened position.

5. The container according to claim 4 characterised in that said angle is selected so that, when the kitchen container (10) is in said bent, fastened position, the tab (15) inserted in the slit (14) protrudes from an upper part of the kitchen container (10) in a position fit to be used as a handle.

6. The container according to claim 4 characterised in that said angle is selected so that, when the kitchen container (10) is in said bent, fastened position, the tab (15) can be released from the slit (14) by pressing the tab (15) or the second side (12b) of the perimetric wall (12) in a direction opposite the insertion direction.

7. The container according to claim 1 characterised in that one of said two opening is an said upper opening formed by the perimetric rim (13) and is substantially circular or elliptical when the kitchen container (10) is in said open position free from external pressure and said two openings formed by the perimetric rim (13) substantially have the form of a tear when the kitchen container (10) is in said bent, fastened position.

8. The container according to claim 1 characterised in that said base (11) has a substantially flat bottom surface when the kitchen container (10) is in an open position free from external pressure.

9. The container according to claim 8 characterised in that the base (11) and the perimetric wall (12) exhibit a common smooth, continuous inner surface.

10. The container according to claim 8 characterised in that the base (11) and the perimetric wall (12) exhibit a common smooth, continuous outer surface.

11. The container according to claim 1 characterised in that said perimetric wall (12) has a progressively increasing thickness from an edge connecting it to the base (11) up to said perimetric rim (13) forming one of the two openings, the one of the two openings being an upper opening.

12. The container according to claim 1 characterised in that said flexible material fit for culinary applications is an elastomer.

13. The container according to claim 12 characterised in that said elastomer is a silicone-based elastomer.

14. The container according to claim 1 characterised in that said portions of the first and second sides (12a, 12b) of the perimetric wall (12) partially overlap each other in said bent, fastened position.

15. The container according to claim 2 characterised in that said fastening elements comprise a slit (14) formed in the first side (12a) of the perimetric wall (12) and a tab (15) extending from the second side (12b) of the perimetric wall (12) to be inserted in said slit (14).

16. The container according to claim 15 characterised in that said tab (15) forms an angle with the second side (12b) of the perimetric wall (12) when the kitchen container (10) is in an open position free from external pressure, said angle being sufficient to retain the tab (15) in the slit (14) when the kitchen container (10) is in a bent, fastened position.

17. The container according to claim 5 characterised in that said angle is selected so that, when the kitchen container (10) is in said bent, fastened position, the tab (15) can be released from the slit (14) by pressing the tab (15) or the second side (12b) of the perimetric wall (12) in a direction opposite the insertion direction.

18. The container according to claim 9 characterised in that the base (11) and the perimetric wall (12) exhibit a common smooth, continuous outer surface.
